(19) United States
(12) Patent Application Publication
(10) Pub. No.: US 2026/0316739 A1
(43) Pub. Date: Oct. 15, 2026

(54) Craft with Improved Motor Pod

(71) Applicant: REGENT Craft Inc., North Kingstown, RI (US)

(72) Inventors: Bradley C. Buskirk, Charlotte, NC (US); Brett C. Peters, Warwick, RI (US)

(73) Assignee: REGENT Craft Inc., North Kingstown, RI (US)

(21) Appl. No.: 19/695,219

(22) Filed: Jun. 2, 2026

Related U.S. Application Data
(63) Continuation of application No. PCT/US2024/058436, filed on Dec. 4, 2024.
(60) Provisional application No. 63/608,943, filed on Dec. 12, 2023.

(51) Int. Cl. B60V 1/14; B60V 1/08

(52) U.S. Cl. CPC B60V 1/14; B60V 1/08

(57) ABSTRACT

In a conventional craft, a motor pod is positioned perpendicular to the radius of the motor (i.e., perpendicular to the rotation of the propeller) and has a symmetric shape. Such a design can create problems, especially with blown wing crafts. The embodiments presented herein can be used to address these problems. In general, the motor pods of these embodiments are canted (non-perpendicular) with respect to the rotation of the propeller and/or have a non-axisymmetric shape. The motor pods of these embodiments can help air flow to reattach more efficiently and help reduce motor pod drag, which improves the lift/drag (L/D) ratio.

### CROSS-REFERENCE TO RELATED APPLICATIONS

This application is a continuation of PCT Application No. PCT/US 2024/058436, filed Dec. 4, 2024, which claims the benefit of U.S. provisional patent application no. 63/608,943, filed on Dec. 12, 2023, both of which are hereby incorporated by reference.

### BACKGROUND

Some crafts (e.g., seagliders) can operate both in water and in the air. In operation, the hull of the craft is in the water as the craft moves around a harbor and begins taxiing. As the craft gains speed, the craft's hydrofoils cause the hull to rise above the surface of the water. As the craft gains even more speed, lift is generated by aerodynamic surfaces of the craft to cause the craft to become airborne. For landing, the craft gradually descends until the hull is back in the water.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

FIG. 1 is a perspective view of an example craft of an embodiment.

FIG. 2A is an illustration of a craft of an embodiment in a hull-borne mode of operation.

FIG. 2B is an illustration of a craft of an embodiment in a hydrofoil-borne maneuvering mode of operation.

FIG. 2C is an illustration of a craft of an embodiment in a hydrofoil-borne takeoff mode of operation.

FIG. 2D is an illustration of a craft of an embodiment in a wing-borne mode of operation.

FIG. 3 is an illustration of a “swirl” problem that is addressed by an embodiment.

FIGS. 4A and 4B are side and front views, respectively, of an air flow problem that is addressed by an embodiment.

FIG. 5 is an illustration of an air un-attachment problem that is addressed by an embodiment.

FIG. 6 is an illustration of an example motor pod of an embodiment.

FIGS. 7A and 7B are views of an example craft of an embodiment.

FIGS. 7C and 7D are views of an example motor pod structure of an embodiment.

FIGS. 8A-8D are views of an example craft of an embodiment.

FIGS. 9A-9D are views of an example craft of an embodiment.

FIGS. 10A-10C are views of an example craft of an embodiment.

FIG. 11 is a diagram of an example motor pod of an embodiment.

FIGS. 12A-12L are diagrams of various views of example motor pods of embodiments.

FIGS. 13A and 13B are top and side views, respectively, that illustrate air flow around an example motor pod of an embodiment.

FIGS. 14A and 14B are top and side views, respectively, that illustrate air flow around an example motor pod of an embodiment.

FIGS. 15A and 15B are top and side views, respectively, that illustrate air flow around an example motor pod of an embodiment.

FIGS. 16A and 16B are bottom perspective views that illustrate air flow around an example motor pod of an embodiment.

FIGS. 17A and 17B are bottom perspective views that illustrate air flow around an example motor pod of an embodiment.

FIG. 18 is a flow chart of a method of an embodiment for controlling/changing a motor pod cant and/or shape during operation.

### DETAILED DESCRIPTION

### I. Introduction

A motor pod is a structure positioned between the propellers and a wing of a craft. In a conventional craft, the motor pod is positioned perpendicular to the radius of the motor (i.e., perpendicular to the rotation of the propeller) and is symmetric about an axis running from the center of the motor radius to the rear tip of the motor pod. Symmetry in the design of the motor pod can be desired for ease of manufacturing and for structural integrity. The design of conventional motor pods can have shortcomings, however, some of which are particularly relevant to blown wing crafts. The embodiments presented herein can be used to address these shortcomings.

In general, the motor pods of some embodiments presented herein are canted (non-perpendicular) with respect to the rotation of the propeller and/or have “non-axisymmetric” (i.e., not exhibiting symmetry around an axis or not exhibiting cylindrical symmetry) shape (e.g., an organic or tulip shape) that is optimized according to air flows and pressures acting on the motor pod. Such a non-axisymmetric shape helps air flow pass more efficiently than in a normal, straight/symmetrical/conventional, motor pod. These embodiments can help reduce motor pod drag, which improves the lift/drag (L/D) ratio. This improvement acts through various operational states of the craft including at both takeoff and cruise, though the benefit is more pronounced in takeoff, where propeller RPM and, thus, airflow is greater so as to facilitate the takeoff process. Also, the increased pressure under the wing due to the improved airflow generates more lift and ensures more airflow through slot gaps formed by flaps in the wing.

### II. Example Craft

The following embodiments can be used with any suitable type of craft. Examples of suitable crafts are described in U.S. Patent Application Nos. Ser. No. 17/885,523; 63/459,197; and 63/493,575 and in PCT/U.S. Pat. No. 2,329,996, each of which is hereby incorporated by reference.

The following paragraphs provide a brief summary of one example craft. The craft in this example takes the form of a wing-in-ground effect vehicle (WIG). A WIG is an aircraft vehicle capable of moving over a surface (e.g., earth or water) by gaining support from the reactions of the air against one or more surfaces of the vehicle. When such a vehicle hovers relatively close to the surface, the drag experienced by the vehicle is reduced and the lift is increased. For example, the drag on a WIG is reduced when its distance from the ground is within about the length of the vehicle's wingspan.

It should be understood that the following summary is merely an example, and that other crafts can be used. So, the various details provided herein and in the patent documents that are incorporated by reference should not be read into the claims unless expressly recited therein. It should also be understood that other crafts and features not described in those documents can be used.

### A. Overview of Example Craft

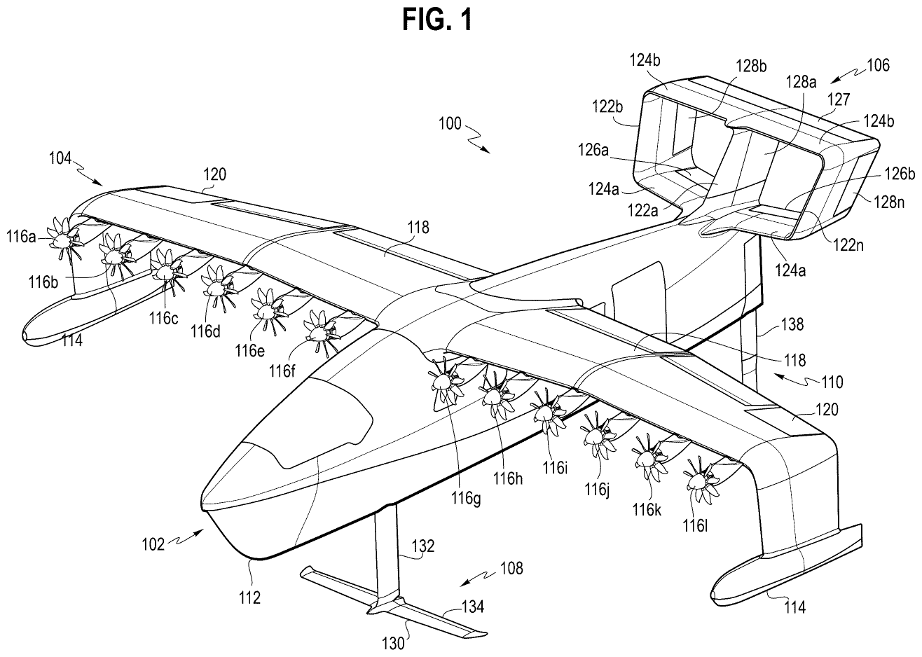

Turning now to the drawings, FIG. 1 is a perspective view of an example craft 100 of an embodiment. As shown, some examples of the craft 100 include a hull 102, a main wing 104, a tail 106, a main hydrofoil assembly 108, and a rear hydrofoil assembly 110.

Some examples of the craft 100 operate in a first waterborne mode for an extended period of time, during which the hull 102 is at least partially submerged in water. As such, some examples of the hull 102 are configured to be watertight, particularly for surfaces of the hull that contact the water during this first waterborne operational mode. Further, some examples of the hull 102, as well as the entirety of the craft 100, are configured to be passively stable on all axes when floating in water. To help achieve this, some examples of the hull 102 include a keel (or centerline) 112, which provides improved stability and other benefits described below. Some examples of the craft 100 include various mechanisms for adjusting the center of mass of the craft 100 so that the center of mass aligns with the center of buoyancy of the craft 100. For instance, in some examples, a battery system (described in further detail below) of the craft 100 is electrically coupled to one or more moveable mounts. Some examples of the mounts are moved by one or more servo motors or the like. In some examples, a control system of the craft 100 is configured to detect a change in its center of buoyancy, for instance, by detecting a rotational change via an onboard gyroscope, and responsively operate the servo motors to move the battery system until the gyroscope indicates that the craft 100 has stabilized. Some examples of the craft 100 include a ballast system for pumping water or air to various tanks distributed throughout the hull 102 of the craft 100. The ballast system facilitates adjusting the center of mass of the craft 100 so that the center of mass aligns with the center of buoyancy of the craft 100. Other example systems may be used to control the center of mass of the craft 100 as well.

Additionally, or alternatively, some examples of the hull 102 are configured to reduce drag forces when both waterborne and wing-borne. For instance, some examples of the hull 102 have a high length-to-beam ratio (e.g., greater than or equal to 8), which facilitates reducing hydrodynamic drag forces when the craft 100 is under forward waterborne motion. Some examples of the keel 112 are curved or rockered to improve maneuverability when waterborne. Further, some examples of the hull 102 are configured to pierce the surface of waves (e.g., to increase passenger and crew comfort) by including a narrow, low-buoyancy bow portion of the hull 102.

Some examples of the main wing 104 include an outrigger 114 at each end of the main wing 104. The outriggers 114 (which are sometimes referred to as “wing-tip pontoons”) are configured to provide a buoyant force to the main wing 104 when submerged or when otherwise in contact with the water, which improves the stability of the craft 100 during waterborne operation.

Some examples of the main wing 104 have a gull-wing shape such that the outriggers 114 at the ends of the main wing 104 are at the lowest point of the main wing 104 and are positioned approximately level with (or slightly above) a waterline of the hull 102 when the hull 102 is waterborne.

Some examples of the main wing 104 have a high aspect ratio, which is defined as the ratio of the span of the main wing 104 to the mean chord of the main wing 104. In some examples, the aspect ratio of the main wing 104 is greater than or equal to five, or greater than or equal to six, but other example aspect ratios are possible as well. Such wings tend to have reduced pitch stability and maneuverability due to lower roll angular acceleration. These issues are ameliorated by various mechanisms described below. On the other hand, such wings tend to have increased roll stability and increased efficiency resulting from higher lift-to-drag ratios. Further, high aspect ratio wings provide a longer leading edge for the mounting of a distributed propulsion system along the wing.

Some examples of the main wing 104 include a number of electric motor propeller assemblies 116 distributed across a leading edge of the main wing 104. This arrangement corresponds to a blown-wing propulsion system. Arranging the propeller assemblies 116 in this manner increases the speed of air moving over the main wing 104, which increases the lift generated by the main wing 104. This increase in lift allows the craft 100 to take off and become wing-borne at slower vehicle speeds. This facilitates, for example, taking off on water which can be difficult at higher speeds due to the various forces that would otherwise act on the craft 100.

The electric motor propeller assemblies 116 tend to be much lighter, less complex, and smaller than the liquid-fueled engines used on conventional craft. Some examples of the electric motor propeller assemblies 116 are controlled by an electronic speed controller and powered by an onboard battery system (e.g., a lithium-ion system, magnesium-ion system, lithium-sulfur system, etc.). Some examples of the electric motor propeller assemblies 116 are controlled by a fuel cell or a centralized liquid-fueled electricity generator. In some examples, the onboard electrical supply system includes multiple systems for supplying power during different operational modes, such as a first battery system configured to deliver large amounts of power during takeoff and a second system with a higher energy density but lower peak power capability for delivering sustained lower power during cruise operation (e.g., during hydrofoil waterborne operation or during wing-borne operation, each of which are described in further detail below).

In some examples, the positioning of the electric motor propeller assemblies 116 along the leading edge of the main wing 104 is determined based on a variety of factors including, but not limited to, (i) the required total thrust for all modes of operation of the craft 100, (ii) the thrust generated by each individual propeller of the propeller assemblies 116, (iii) the radius of each propeller in the respective propeller assemblies 116, (iv) the required tip clearance between each propeller and the surface of the water, and (v) the additional freestream speed over the main wing 104 required for operation.

As shown in the figures, in some examples, the number of propeller assemblies 116 is symmetrical across both sides of the hull 102. In some examples, the propeller assemblies 116 are identical. In some examples, the propeller assemblies 116 have different propeller radii or blade configurations along the span so long as the configuration is symmetrical across the hull 102. The different radii facilitate adequate propeller tip clearance from the water or vehicle structure. In some examples, the different propellers are optimized for different operational conditions, such as wing-borne cruise. The propeller placement and configuration may vary to increase the airflow over the main wing 104 or tail system 106 to improve controllability or stability. While eight total propeller assemblies 116 are illustrated, the actual number of propeller assemblies 116 can vary based on the requirements of the craft 100.

In some examples, the propeller assemblies 116 have different pitch settings or variable pitch capabilities based on their position on the main wing 104. For instance, in some examples, a subset of the propeller assemblies 116 have fixed-pitch propellers sized for cruise speeds, while the remainder of the propeller assemblies 116 have fixed-pitch propellers configured for takeoff or can allow for varying the propeller's pitch.

In some examples, different propeller assemblies 116 are turned off or have reduced rotational speeds during different modes of operation. For instance, during waterborne operation, one or more of the propeller assemblies 116 may be turned off or have reduced rotational speeds in a manner that generates asymmetrical thrust. This may create a yawing moment on the craft 100, allowing the craft 100 to turn without large bank angles and increasing the turning maneuverability of the craft 100. For instance, in order to yaw right, the craft 100 may increase the rotational speeds of the propellers of one or more of propeller assemblies 116g-l while decreasing the rotational speeds of the propellers of one or more of propeller assemblies 116a-f. Similarly, to yaw left, the craft 100 may increase the rotational speeds of the propellers of one or more of propeller assemblies 116a-f while decreasing the rotational speeds of the propellers of one or more of propeller assemblies 116g-l.

Similarly varying rotational speeds or propeller pitches may be used to yaw or roll the aircraft in flight or while foiling due to varied forces and lift distributions imposed over the wing and its control surfaces or in general used to tailor the lift distribution across the wing for optimized efficiency.

In some examples, the propeller assemblies may tilt to vector thrust either to provide directly more vertical lift or to change how the wing is blown depending on the mode of operation so as to tailor the blown lift distribution.

Some examples of the main wing 104 include one or more aerodynamic control surfaces, such as flaps 118 and ailerons 120. Some examples of these controls comprise movable hinged surfaces on the trailing or leading edges of the main wing 104 for changing the aerodynamic shape of the main wing 104. Some examples of the flaps 118 are configured to extend downward below the main wing 104 to reduce stall speed and create additional lift at low airspeeds, while some examples of the ailerons 120 are configured to extend upward above the main wing 104 to decrease lift on one side of the main wing 104 and induce a roll moment in the craft 100. In some examples, the ailerons 120 are additionally configured to extend downward below the main wing 104 in a flaperon configuration to help the flaps 118 generate additional lift on the main wing 104, which, in some examples, is used to either create a rolling moment or additional balanced lift depending on coordinated movement of both ailerons. Some examples of the flaps 118 and ailerons 120 include one or more actuators for raising and lowering the flaps 118 and ailerons 120. Within examples, the flaps 118 include one or more of plain flaps, split flaps, slotted flaps, Fowler flaps, slotted Fowler flaps, Gouge flaps, Junkers flaps, or Zap flaps. Further, in some examples, the flaps 118 (and the ailerons 120 when configured as flaperons) are positioned to be in the wake of one or more of the propeller assemblies 116. In some examples, the ailerons 120 are positioned so that they are in the wake of one or more of the propeller assemblies 116 to increase the effectiveness of the ailerons at low forward velocities. Some of the propeller assemblies 116 are positioned so that no ailerons 120 are in their wake to increase thrust on the outboard wing during a turn without inducing adverse yaw. For example, in a left turn, a normal airplane would have adverse yaw to the right as the right aileron is deflected down, increasing drag. In the present disclosure, however, the right propeller assembly outboard of the right aileron may have its thrust increased relative to the respective left propeller assembly, initiating a turn without adverse yaw.

As illustrated in FIG. 1, an example tail 106 includes a vertical stabilizer 122, a horizontal stabilizer 124, and one or more control surfaces, such as elevators 126. Similar to the flaps 118 and ailerons 120, some examples of the elevators 126 comprise movable hinged surfaces on the trailing or leading edges of the horizontal stabilizer 124 for changing the aerodynamic shape of the horizontal stabilizer 124 to control a pitch of the craft 100. Some examples of the horizontal stabilizer 124 are combined with the elevators 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. Some examples of the elevators 126 include actuators, which are operated by a control system of the craft 100 to raise and lower the elevators 126.

Some examples of tail 106 include a rudder 128. Some examples of the rudder 128 comprise a movable hinged surface on the trailing edge of the vertical stabilizer 122 for changing the aerodynamic shape of the vertical stabilizer 122 to control the yaw of the craft 100 when operating in an airborne mode. In some examples, the rudder 128 additionally changes a hydrodynamic shape of the hull 102 to control the yaw of the craft 100 when operating in a waterborne mode. To facilitate such hydrodynamic control, in some examples, the rudder 128 is positioned low enough on the tail 106 that the rudder 128 is partially or entirely submerged when the hull 102 is floating in water. For instance, the rudder 128 is positioned partially or entirely below the waterline of the hull 102. Some examples of the rudder 128 include one or more actuators, which are operated by a control system of the craft 100 to rotate the hinged surface of the rudder 128 to the left or right of the vertical stabilizer 122. Actuating the rudder 128 to the left (relative to the direction of travel) causes the craft 100 to yaw left. Actuating the rudder 128 to the right (relative to the direction of travel) causes the craft 100 to yaw right. As such, the rudder 128 may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

Some examples of the tail 106 include one or more vertical stabilizers 122a, 122b, 122n, one or more horizontal stabilizers 124a, 124b, one or more control surfaces, such as elevators 126, and one or more tail flaps 127 for enhanced pitch control configured to exert enhanced net downward force on the tail system. It should be understood that although the figures show only two horizontal stabilizers, it is contemplated that more than two of each can be used within the scope of the present teachings. In some applications, it has been found that the transition from waterborne operation to airborne or wing-borne operation can require a larger pitching moment to overcome the larger drag forces existing between the hull 102 and/or the hydrofoil assemblies 108, 110 and the water. This phenomenon can further occur in wheeled aircraft configured for short takeoff and landing (STOL) operations. In this way, at low airspeeds, aerodynamic forces in conventional designs fail to produce sufficient downward force to permit sufficient pitching moment. To provide sufficient pitching moment to pitch the craft 100 upward, a conventional solution would be to increase the span of the tail so that the elevator generates more force; however, a resultant consequence of increasing the span of the tail is that the entire tail must be stronger and heavier, which can result in undesired reduction of payload and efficiency. However, the present configuration provides improved performance by providing a tail 106 having a first horizontal stabilizer 124a and a second horizontal stabilizer 124b. It should be understood that one or more additional horizontal stabilizers can be used.

In some examples, a first horizontal stabilizer 124a is a lower horizontal stabilizer relative to a second horizontal stabilizer 124b. However, it should be appreciated that the horizontal stabilizers in some examples can be interchanged for performance purposes (e.g., the disclosed structure of the first horizontal stabilizer 124a can be incorporated in the upper horizontal stabilizer and the disclosed structure of the second horizontal stabilizer 124b can be incorporated in the lower horizontal stabilizer). In some non-limiting examples, the structure, shape, and/or performance of each horizontal stabilizer can be tailored as desired such that the lower horizontal stabilizer (in this example, the first horizontal stabilizer 124a) is more likely to experience aerodynamic effect from being in the wake of the blown-wing propulsion system disclosed herein or associated wake produced by alternative propulsion systems. In this way, greater aerodynamic control and/or downwards lift can be generated during desired phases of operation.

Some examples of the horizontal stabilizers 124a, 124b include one or more aerodynamic control surfaces, such as tail flaps 127 and elevators 126, which may comprise movable hinged surfaces on the trailing or leading edges of the horizontal stabilizer 124a, 124b for changing the aerodynamic shape of the respective horizontal stabilizer 124a, 124b. It should be recognized that at least one of the horizontal stabilizers 124a, 124b can be sized, shaped, and/or spaced relative to a second of the horizontal stabilizers 124a, 124b to enhance or minimize the aerodynamic effect on the adjacent stabilizers. In this way, the aerodynamic flow, pressures, and/or forces can be used to improve the efficiency or effectiveness of the adjacent stabilizer. In some examples, at least one of the horizontal stabilizers 124a, 124b can be actuated in an opposing direction. In some embodiments, at least one of the horizontal stabilizers 124a, 124b can define a ratio of a surface area of the first horizontal stabilizer to a surface area of the second horizontal stabilizer in the range of 0.9 to 1.6. In some non-limiting example configurations, the surface area of the first horizontal stabilizer is 5.7 m2, the surface area of the second horizontal stabilizer is 3.9 m2, both have a chord of about 1 m and a vertical separation of 1.8 m. In some embodiments, a vertical separation distance between the first horizontal stabilizer and the second horizontal stabilizer is in the range of 0.25 to 0.75 of the lower horizontal stabilizer span. In some examples, a vertical separation distance can be dependent on the required rudder authority and thus elevator size (driven by, e.g., yaw stability, or the need to counteract asymmetric thrust following powerplant failure). In some examples, a sweep offset moves the center of pressure further aft from the center of gravity, thus allowing the airfoil of the horizontal stabilizer to have less surface area overall, thus being smaller and lighter. In some examples, a dihedral in the bottom surface of the horizontal stabilizer adds stability. In some examples, the box tail design itself increases the efficiency due to the elimination of wingtip vortices of a typical tail. In some embodiments, a lower horizontal stabilizer may have approximately a 15% thickness-to-chord ratio to support the weight of the upper components, whereas the vertical and upper surfaces may be thinner, such as, for example, 10% thickness-to-chord ratio due to reduced structural load requirement, which enables the upper horizontal stabilizer to be more efficient (lower drag). It should be appreciated that the left and right elevator surfaces 126 can be controlled independently and/or differentially to create a rolling moment, thereby enabling the wing ailerons 120 to be made smaller. The smaller wing ailerons 120 further enable larger flaps 118. It should be appreciated that in some embodiments, using the vertical control surfaces 128a, 128b, 128n can change the pressure distribution across the elevator 126, for example, commanding a left 5 degree deflection in the left vertical control surface may move the mean pressure distribution left/right by a percentage of the elevator width.

Some examples of the tail flaps 127 are configured to selectively extend upward above the horizontal stabilizer 124 for changing a surface area, camber, aspect ratio, and/or shape of the horizontal stabilizer 124. The tail flaps 127 may include, for example, one or more of plain flaps, split flaps, slotted flaps, Fowler flaps, slotted or double-slotted Fowler flaps, Gouge flaps, Junkers flaps, or Zap flaps. That is, in some examples, tail flaps 127 serve to change an angle of attack of the horizontal stabilizer 124, change a chord line of the horizontal stabilizer 124, change a surface area of the horizontal stabilizer 124, and/or otherwise increase the net effective downwardly directed lift of the horizontal stabilizer 124. Such configurations effectively reduce the speed at which the horizontal stabilizer 124 becomes aerodynamically effective by creating additional net downward force at low airspeeds to aid in exerting a nose-up pitching moment of the craft 100. The elevators 126 may be configured for changing the aerodynamic shape of the horizontal stabilizer 124 to further control or vary a pitch of the craft 100.

In some examples operations, the tail flaps 127 are deployed for takeoff (e.g., transition from hydrofoil-borne mode to airborne mode) and landing (e.g., transition from airborne mode to hull-borne mode) to generate additional downforce on the tail system when additional pitch-up moment is required. Tail flaps 127 can be stowed for other phases of operation, such as hull-borne mode, to reduce downforce on the tail system and reduce drag.

In some examples, the elevators 126 are additionally configured to extend upward above the horizontal stabilizer 124 in a flaperon-like configuration (yet with elevators, rather than ailerons) to help the tail flaps 127 generate additional downward force on the horizontal stabilizer 124, which may be used to either create a pitching moment or additional balanced downward force. The tail flaps 127 and elevators 126 may each include one or more actuators 125 for raising and lowering the tail flaps 127 and elevators 126, singly or in combination. The actuators 125 can comprise any system configured to selectively actuate the associated system, such as but not limited to a flap track system (integrated into vertical stabilizers 122a, 122b, 122n, which can reduce complex hinge systems or external arms, thereby reducing wetted area and excrescences drag), an electric servo motor mounting within the vertical stabilizers 122a, 122b, 122n and/or horizontal stabilizers 124a, 124b, and/or a central vertical strut system generally mounted in the hull 102 or the fuselage of the craft 100 (to provide the potential for reduced cross-sectional area and associated drag).

Further, in some examples, the elevators 126 and/or the tail flaps 127 are positioned so that they are in the wake 129 of one or more of the propeller assemblies 116 of main wing 104. The elevators 126 and/or the tail flaps 127 may be positioned so that they are in the wake 129 of one or more of the propeller assemblies 116 to increase the effectiveness of the elevators at low forward velocities. In some examples, the propeller assemblies 116 are positioned so that no elevators 126 and/or tail flaps 127 are in the wake 129 to ensure consistent and/or predictable aerodynamic forces, independent of power application, are exerted during critical operational phases. In some examples, the propeller assemblies 116 are positioned so that the elevators 126 are in their wake 129 and the tail flaps 127 are not in the wake 129 (e.g., above the wake 129) and are exposed to clean air 131. It should be understood that positioning of the tail flaps 127 in the second horizontal stabilizer 124b, or at a distance above the center of gravity of the craft 100, will have the added unexpected benefit of creating additional nose-up pitching moment as a result of induced drag acting about the center of gravity causing the craft 100 to pitch upward.

Similar to the flaps 118 and the ailerons 120 of the main wing 104, some examples of the elevators 126 comprise movable hinged surfaces on the trailing or leading edges of the horizontal stabilizer 124 for changing the aerodynamic shape of the horizontal stabilizer 124 to control a pitch of the craft 100. The horizontal stabilizer 124 may be combined with the elevator 126, creating a fully articulating horizontal stabilizer (e.g., a stabilator). Raising the elevators 126 above the hinge point creates a net downward force on the tail system and causes the craft 100 to pitch upward. Lowering the elevators 126 below the hinge point creates a net upward force on the horizontal stabilizer 124 and causes the craft 100 to pitch downward. The elevators 126 may include actuators, which may be operated by a control system of the craft 100 in order to raise and lower the elevators 126.

In some examples, the tail 106 includes one or more rudders 128a, 128b, 128n. The rudders 128a, 128b, 128n may each comprise a movable hinged surface on the trailing edge of the corresponding vertical stabilizers 122a, 122b, 122n for changing the aerodynamic shape of the vertical stabilizer 122 to control the yaw of the craft 100 when operating in an airborne mode. It should be understood that rudders 128a, 128b, 128n can operate independently or in combination as desired. Moreover, in some examples, rudders 128a, 128b, 128n can be used as redundant systems, particularly useful in the event of one or more failures.

In some examples, the rudders 128a, 128b, 128n additionally change a hydrodynamic shape of the hull 102 to control the yaw of the craft 100 when operating in a waterborne mode. In order to facilitate such hydrodynamic control, the rudders 128a, 128b, 128n may be positioned low enough on the tail 106 that one or more of the rudders 128a, 128b, 128n is partially or entirely submerged when the hull 102 is floating in water. Namely, the rudders 128a, 128b, 128n may be positioned partially or entirely below a waterline of the hull 102. The rudders 128a, 128b, 128n may include one or more actuators, which may be operated by a control system of the craft 100 in order to rotate the hinged surface of the rudders 128a, 128b, 128n to the left or right of the vertical stabilizer 122. Actuating the rudders 128a, 128b, 128n to the left (relative to the direction of travel) causes the craft 100 to yaw left. Actuating the rudders 128a, 128b, 128n to the right (relative to the direction of travel) causes the craft 100 to yaw right. As such, the rudders 128a, 128b, 128n may be used in combination with any of the other mechanisms disclosed herein for controlling the yaw of the craft 100, including in combination with the ailerons 120 during airborne operation and in combination with varying the rotational speeds of different ones of the propeller assemblies 116 to help improve the maneuverability of the craft 100 during waterborne operation.

It should be understood that the fundamental shape of tail 106, having one or more vertical stabilizers 122a, 122b, 122n and one or more horizontal stabilizers 124a, 124b, can result in a box-like assembly, wherein the vertical stabilizers are generally coupled to the horizontal stabilizers to form a reinforced box-like construction. This box-like construction provides enhanced structural integrity that enables tail 106 of some examples to be lighter and/or smaller than otherwise constructed.

Some examples of the craft 100 include a distributed propulsion system on the tail 106, which may be similar to the distributed propulsion system of propeller assemblies 116 on the main wing 104. Such a distributed propulsion system may provide similar benefits of increasing the freestream velocity over the control surfaces (e.g., the elevators 126 and/or the rudder 128) to allow for increased pitch and yaw control of the craft 100 at lower travel speeds. When determining the number and size of propeller assemblies to include on the tail 106, one may apply the same factors described above when determining the number and size of propeller assemblies to include on the main wing 104.

### B. Example Modes of Operation

The craft 100 can be operated in a plurality of modes of operation, examples of which are described below.

### 1. Hull-Borne Operation

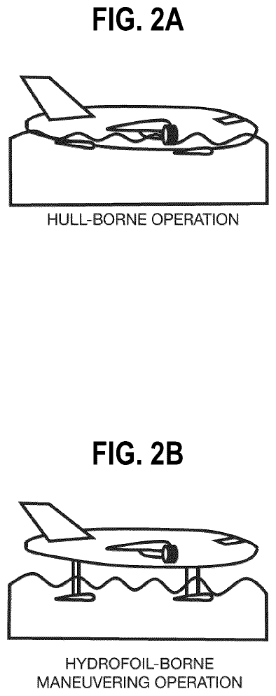

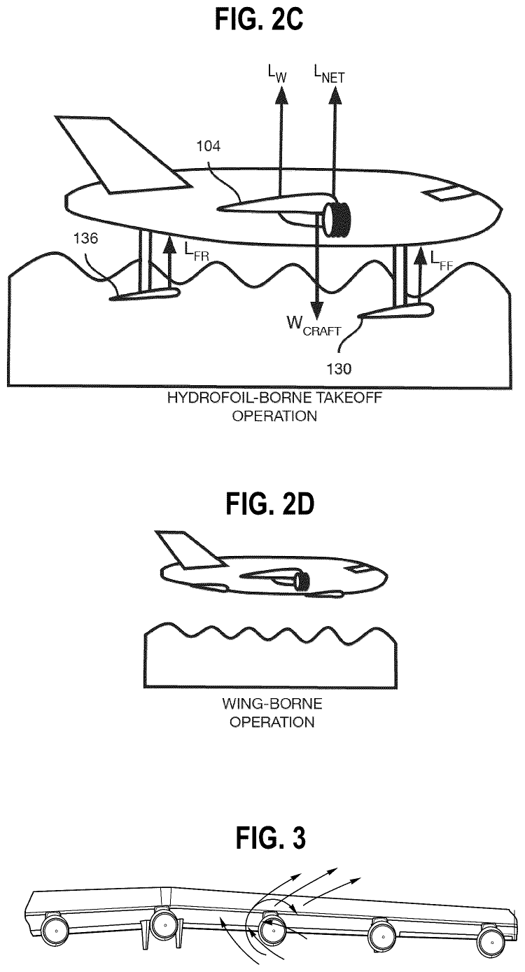

FIG. 2A illustrates an example of the craft 100 when the craft 100 is operating in a hull-borne mode. During this mode, the craft 100 is docked and floating on the hull 102, with the buoyancy of the outriggers 114 providing for roll stabilization of the craft 100. When the craft 100 is ready to depart, the craft 100 uses its propulsion systems, including the propeller assemblies 116 and/or the underwater propulsion system (e.g., one or more propellers mounted to the hull 102, the main foil 130, and/or the rear foil), to maneuver away from the dock while remaining hull-borne. In some examples, the main hydrofoil assembly 108 and the rear hydrofoil assembly 110 remain retracted (or partially retracted) during this maneuvering to reduce the risk of hitting underwater obstacles near docks or in shallow waterways. However, when there is a limited risk of hitting underwater obstacles, the craft 100 may partially or fully extend the main hydrofoil assembly 108 and/or the rear hydrofoil assembly 110. With the main hydrofoil assembly 108 and/or the rear hydrofoil assembly 110 extended, the craft 100 actuates the main foil control surfaces 134 and/or the rear foil control surfaces to improve maneuverability as described above.

### 2. Hydrofoil-Borne Maneuvering Operation

FIG. 2B illustrates an example of the craft 100 when the craft 100 is operating in hydrofoil-borne maneuvering mode. During this mode, the craft 100 is configured to, for example, move through harbors and crowded waterways at speeds generally between 20-45 mph. In this regard, the craft 100 may extend the main hydrofoil assembly 108 and the rear hydrofoil assembly 110 (if not already extended) and accelerate using the propulsion system towards a desired takeoff speed. During acceleration, the craft 100 reaches a speed at which the main hydrofoil assembly 108 and the rear hydrofoil assembly 110 alone support the weight of the craft 100, and the hull 102 is lifted above the surface of the water (e.g., by 3-5 ft) so that the hull is clear of any surface waves. After the hull 102 leaves the surface of the water, the drag forces exerted on the craft 100 drop significantly, and the amount of thrust required to maintain acceleration can be reduced. The control system of the craft 100 can sustain this operational mode by actively controlling the pitch and speed of the craft 100, so that the main hydrofoil assembly 108 and the rear hydrofoil assembly 110 continue to entirely support the weight of the craft 100.

The height at which the hull 102 is elevated above the surface of the water during hydrofoil-borne operation is limited by the length of the one or more main foil struts 132 that couple the main foil 130 to the hull 102 and the length of the one or more rear foil struts 138 that couple the rear foil (not shown) of the rear foil struts 138 to the hull 102. In some examples, the main foil struts 132 and the rear foil struts 138 are long enough to lift the hull 102 at least five feet above the surface of the water during hydrofoil-borne operation, which facilitates operation in water with larger wave heights (e.g., wave heights up to five feet). However, struts of other lengths can be used as well. For instance, some examples may utilize longer struts that allow for better wave-isolation of the hull 102 (but at the expense of the stability of the craft 100 and the increased complexity of the retraction system).

### 3. Hydrofoil-Borne Takeoff Operation

FIG. 2C illustrates an example of the craft 100 when the craft 100 is operating in hydrofoil-borne takeoff mode. During this mode, the craft 100 is configured to, for example, move through open waters and obtain speeds generally between 40-50 mph to facilitate generating the lift required to become wing-borne. As the craft 100 moves through water with the main foil 130 and the rear foil (not shown) of the rear foil struts 138 submerged, the foils generate a lifting force that causes the hull 102 to rise above the surface of the water. In general, the lifting force generated by the foils must be at least equal to the weight of the craft 100 to cause the hull 102 to rise above the surface of the water. The lifting force of the foils depends on the speed and angle of attack at which the foils move through the water, as well as their various physical dimensions, including the aspect ratio, the surface area, the span, and the chord of the foils.

In general, as shown in FIG. 2C, to sustain takeoff and accomplish flight, the aero lift L_{W} generated by the wings and the aero lift L_{FR}, L_{FF} generated by the main and rear foils 130, 136 (the sum of which is represented in FIG. 2C as L_{NET}) should exceed the weight, W_{CRAFT}, of the craft. Once a sufficient lift is achieved, the craft 100 becomes wing borne, as shown in FIG. 2D. In some examples, once the transition from hydrofoil-borne operation to wing-borne operation is complete, the control system of the craft causes the main hydrofoil assembly 108 and the rear hydrofoil assembly 110 to retract. In some examples, the control system initiates this retraction as soon as the hydrofoil assemblies 108, 110 are clear of the water to reduce the chance of the hydrofoil assemblies 108, 110 reentering the water.

### 4. Return to Hull-Borne Operation

To facilitate transitioning from wing-borne to hull-borne mode of operation (from FIG. 2D to FIG. 2A), the control system of the craft 100 can determine that the hydrofoil assemblies 108, 110 are fully retracted so that the craft 100 may safely land on its hull 102. However, in other examples, the hydrofoil assemblies 108, 110 are at least partially deployed when the craft 100 lands, so the hydrofoil assemblies 108, 110 impact the water during landing.

In some examples, after the craft 100 is settled in the water, the craft 100 is transitioned back to hydrofoil-borne maneuvering mode (see FIG. 2B) by extending the hydrofoil assemblies 108, 110 to transition from hull-borne operation to hydrofoil-borne operation in the same manner as described above. In some examples, the control system of the craft 100 then sustains the hydrofoil-borne mode and maneuvers the craft 100 into port while keeping the hull 102 insulated from surface waves. The control system of the craft 100 can then reduce the thrust generated by the propeller assemblies 116 to lower the speed of the craft 100 until the hull 102 settles into the water, thereby transitioning that craft back to hull-borne operation. The control system of the craft 100 can then retract the hydrofoil assemblies 108, 110 and perform the hull-borne operations described above to maneuver the craft 100 into a dock for disembarking passengers or goods and recharging the battery system 200.

### III. Motor Pod

As mentioned above, a motor pod is a structure positioned between the propellers and a wing of a craft. In a conventional craft, the motor pod is positioned perpendicular to the radius of the motor (i.e., perpendicular to the rotation of the propeller) and is a symmetric about an axis running from the center of the motor radius to the rear tip of the motor pod. Symmetry in the design of the motor pod can be desired for ease of manufacturing and for structural integrity. The design of conventional motor pods can have shortcomings, however, some of which are particularly relevant to blown wing crafts. The embodiments presented herein can be used to address these shortcomings.

In general, the motor pods of some embodiments presented herein are canted (non-perpendicular) with respect to the rotation of the propeller and/or have “non-axisymmetric” (i.e., not exhibiting symmetry around an axis or not exhibiting cylindrical symmetry) shape (e.g., an organic or tulip shape) that is optimized according to air flows and pressures acting on the motor pod. Such non-axisymmetric shape helps air flow pass more efficiently than in a normal, straight/symmetrical/conventional, motor pod. These embodiments can help reduce motor pod drag, which improves the lift/drag (L/D) ratio. This improvement acts through various operational states of the craft including at both takeoff and cruise, though the benefit is more pronounced in takeoff, where propeller RPM and, thus, airflow is greater so as to facilitate the takeoff process. Also, the increased pressure under the wing due to the improved airflow generates more lift and ensures more airflow through slot gaps formed by flaps in the wing.

### A. Example Motor Pod Considerations

One consideration with conventional motor pods is the “swirl problem.” Propellers generate “swirling” air flow depending on their geometries. However, this “swirl problem” can be particularly problematic for crafts, such as the one discussed above, that are designed to operate (take off) at a relatively low speed while, at the same time, spinning the propeller at a high speed, as such a combination can generate a relatively-large amount of swirling air flow. This unique operating condition results from attempting to generate a large amount of thrust via blowing air over the wing, which inherently creates conditions for greater-than-usual amounts of swirl. The physics leading to swirl are part of any propeller, as there will always be air rotation. However, with a blown wing craft, the way the swirl from the propeller interacts with the leading edge of the_wing can cause an undesirable pressure differential.

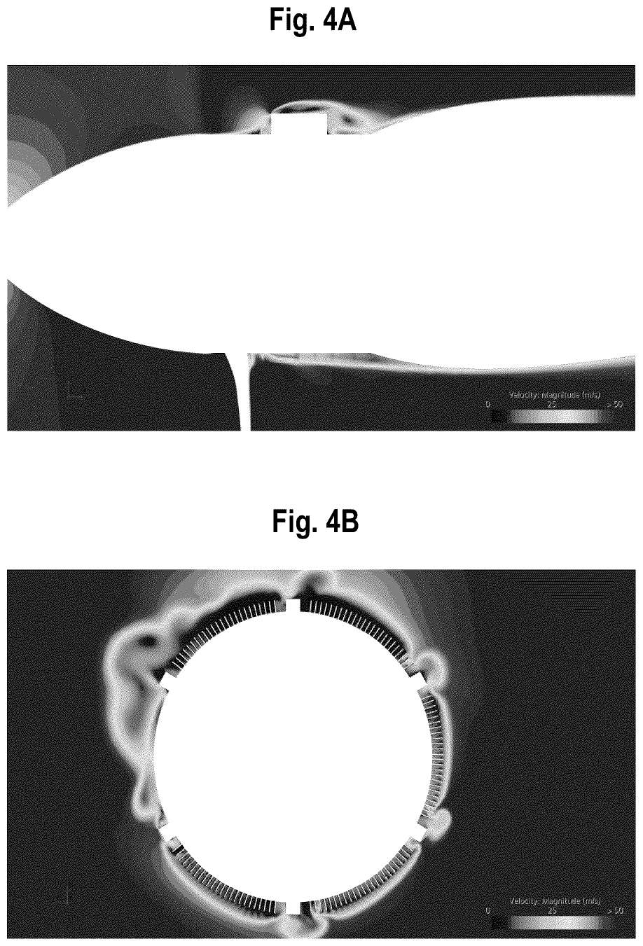

This consideration is illustrated in FIG. 3. As shown in FIG. 3, air flow in the clockwise direction (right to the top of the wing, left to the bottom of the wing) results in air flow in different directions above and below the wing. This tends to cause differential pressure acting on the motor pod under normal conditions. As the propeller spins, there is a swirl_component in front of the wing that the wing cuts in half. This is what causes a spanwise component in the air flow. Also, the differential pressure depicted in FIG. 3 can be exacerbated by designs where the motor pod/propeller is “off center” out-of-line with the leading edge of the wing (e.g., where the propeller is mounted below the leading edge of the wing).

Other aspects of the motor pod design can cause undesirable air flow separation. For example, if the motor pod includes integrated (but external) cooling fins to cool the motor by air instead of liquid, the height and quantity of the cooling fins can impact turbulence. As another example, if the motor pod contains a protrusion to house a component (e.g., a connector box connecting DC high voltage to an inverter), the protrusion can disrupt air flow and cause turbulence. FIGS. 4A and 4B are side and front views, respectively, of a motor pod, which illustrates the air flow problems caused by an example protrusion (shown at the top of FIG. 4A and at approximately the “10:30” position in FIG. 4B) and example fins (shown in the inner diameter of the motor pod in FIG. 4B). As shown in the light and dark blue colored regions in FIGS. 4A and 4B, the cooling fins and protruding connector box introduce turbulence between the different flow regimes, showing that there is significant air separation caused by the cooling fins and protruding connector box. For example, as shown in FIG. 4A, the fins act as “capillaries” that intake the air and slow it down. This results in the air flow “losing attachment” relative to the propeller/motor/motor pod structure. Such air that becomes unattached will typically undesirably impact the efficiency and performance of the craft.

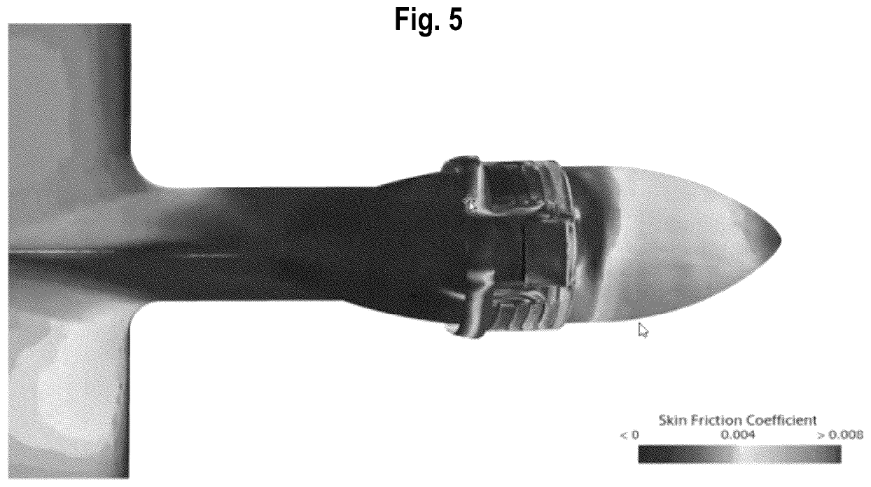

This problem is also illustrated in FIG. 5, depicting an example of a conventional propeller and motor pod exhibiting air un-attachment in operation. In FIG. 5, the color blue shows that air remains detached from the motor pod after passing behind the motor.

As air continues to flow past the motor pod and onto the wing, unattached air can continue to have an undesirable effect. For instance, undesirable separation of air flow might also be observed on a flap on the wing, at the rear/back of a motor pod. The separation of air flow at this location can lead to decreased lift.

### B. Example Motor Pod Implementations

The following embodiments describe a motor pod that can be used to reduce air flow “separation” and help equalize air flow pressures. In one embodiment, the motor pod is canted (i.e. positioned non-perpendicularly to the radius of the motor/rotation of the propeller) and/or has a non-axisymmetric shape (i.e., a shape that is non-axisymmetric about an axis running from the center of the motor radius to the rear tip of the motor pod). These two motor pod designs can be used alone or in combination. That is, in some embodiments, the motor pod is both canted and has a non-axisymmetric shape, while, in other embodiments, the motor pod is canted but has a symmetric shape, or is not canted but has a non-axisymmetric shape. The following paragraphs describe various example implementations. It should be understood that these are merely examples and that the details presented herein should not be read into the claims unless expressly recited therein.

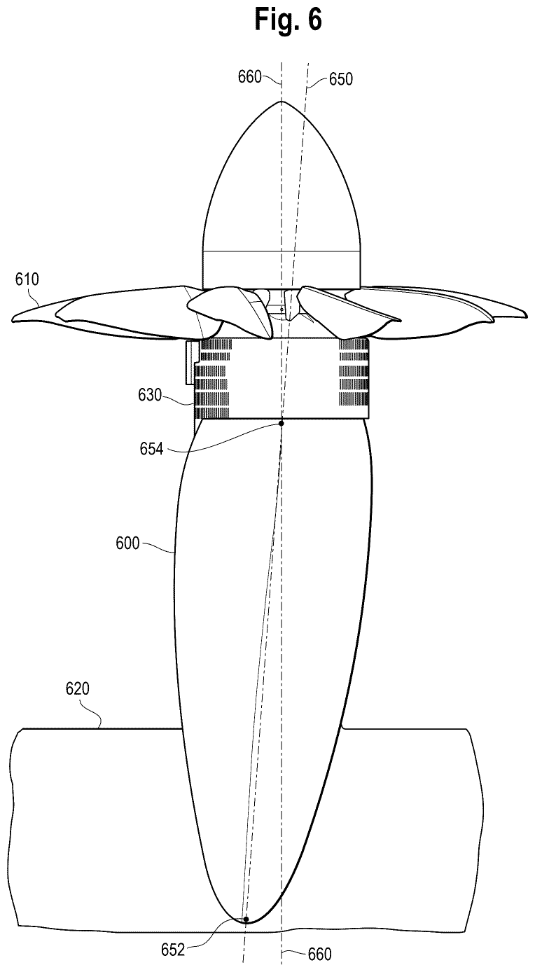

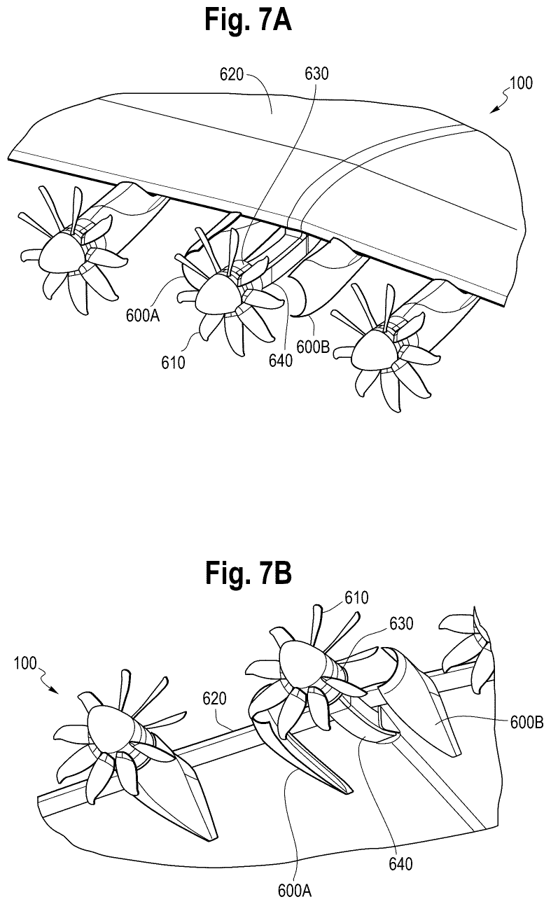

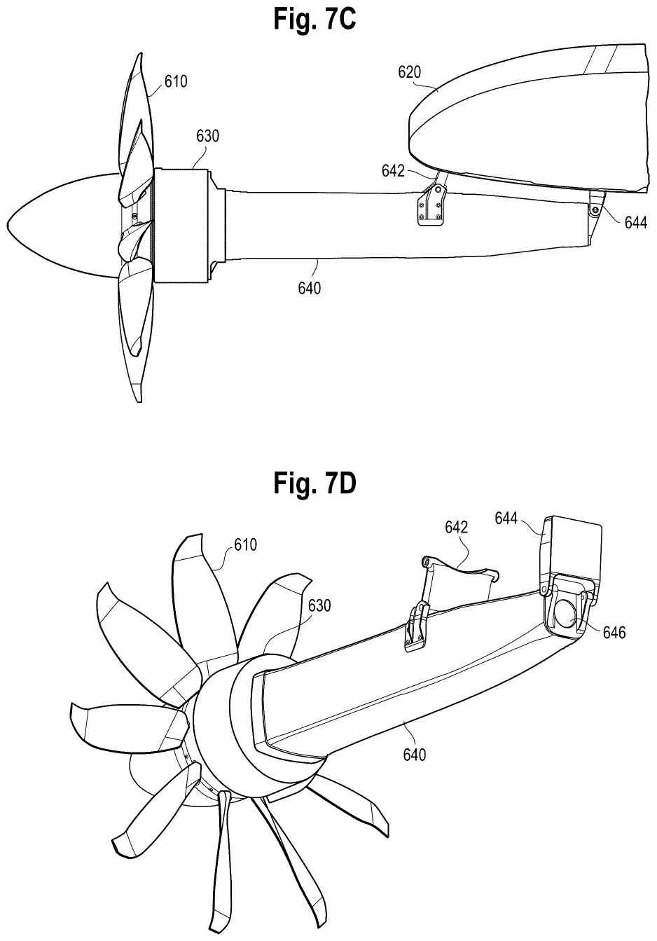

Turning again to the drawings, FIG. 6 is an illustration of a motor pod 600 of an embodiment, which is positioned between the propellers 610 and wing 620 of a craft. As shown in the perspective views in FIGS. 7A and 7B, in this embodiment, the motor 630 is attached to the wing 620 via a support structure 640, and the motor pod 600 comprises two halves 600A, 600B that cover the support structure 650 and also cover a portion of the motor 630 (and, optionally, other components, such as power, communication, and/or control lines).

As shown, in this embodiment, the motor pod 600 is coupled with the wing 620 in that the motor pod 600 contacts (and may be secured to) the wing 620 via support structure 640 but does not actually structurally support the motor 630. Notably, elements other than support structure 640 might be included within the enclosure of two halves 600A and 600B including, for example, power components, communications components, avionics, control system components, and/or other electrical components. Use of such a covered support structure might be desirable for a variety of reasons, with examples including the geometry of the support structure might be relatively simple (such as at least partially symmetric, and/or axisymmetric) and therefore relatively more structurally sound, easier to manufacture, and/or less complex and expensive to manufacture. Moreover, both the cover and the support structure might be relatively easier and less expensive to repair than a motor pod cover that itself structurally supports the motor.

FIGS. 7C and 7D show an example embodiment of a support structure 640 between the motor 630 and the wing 620 that may be included within the motor pod 600. The support structure 640 is attached to the wing 620 using two attachment structures 642 and 644. Although the attachment structures 642 and 644 are shown to hold the support structure 640 in a fixed position, alternative structures could be actuated to adjust the propeller's position vertically or horizontally. In one example, increasing or decreasing the depth in 642 can provide active drooping, which may be beneficial in some scenarios. FIG. 7D shows an opening 646 that can be used, for example, to house other components, such as power components, communications components, avionics, control system components (including sensors), hydraulic lines, and/or other electrical components. The opening 646 can also be used for thermal energy transfer. In one example, warm air from the motor passes through the opening 646 to cool the motors. In another example, coolant lines passing through opening 646 can recirculate cool water to the motors for cooling. In some examples, coolant lines can pull water through openings in the hydrofoils when they are in contact with water (e.g., when the craft is in hull mode or foil mode). The coolant lines can pass through the hydrofoil struts and are distributed to the motors for cooling. Additionally or alternately, coolant lines can pull water through openings in the hull when the hull is in contact with the water (e.g., when the craft is in hull mode). The coolant lines carrying water can be distributed to the motors (or other areas of the craft that need cooling).

In other embodiments, the motor pod 600 does structurally support the motor 630 rather than just acting as a cover around a support structure such as support structure 640 in FIGS. 7A-7D. A potential benefit of such an approach includes, among other benefits, if the internal space of the motor pod does not include a separate support structure, then that space might be used to house other components such as power components, communications components, avionics, control system components, and/or other electrical components.

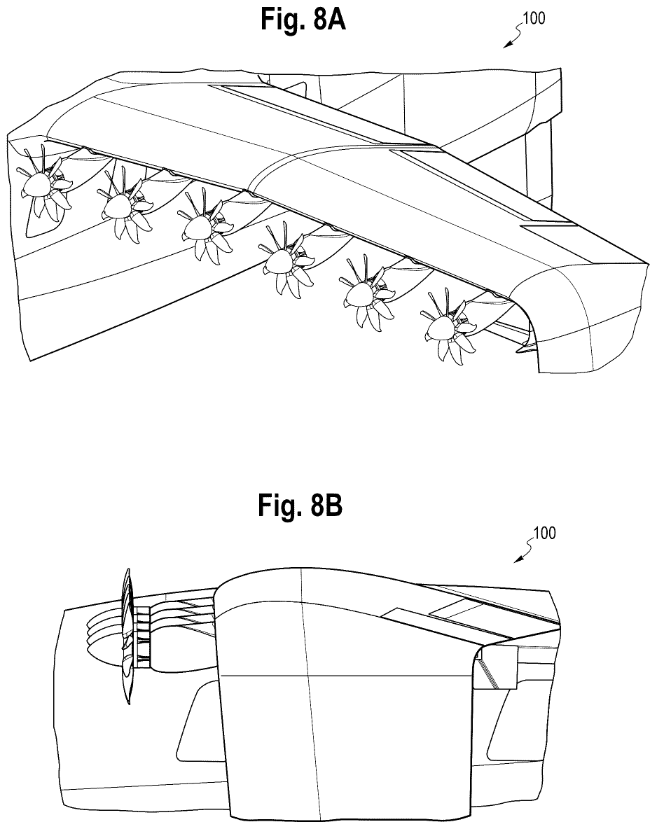

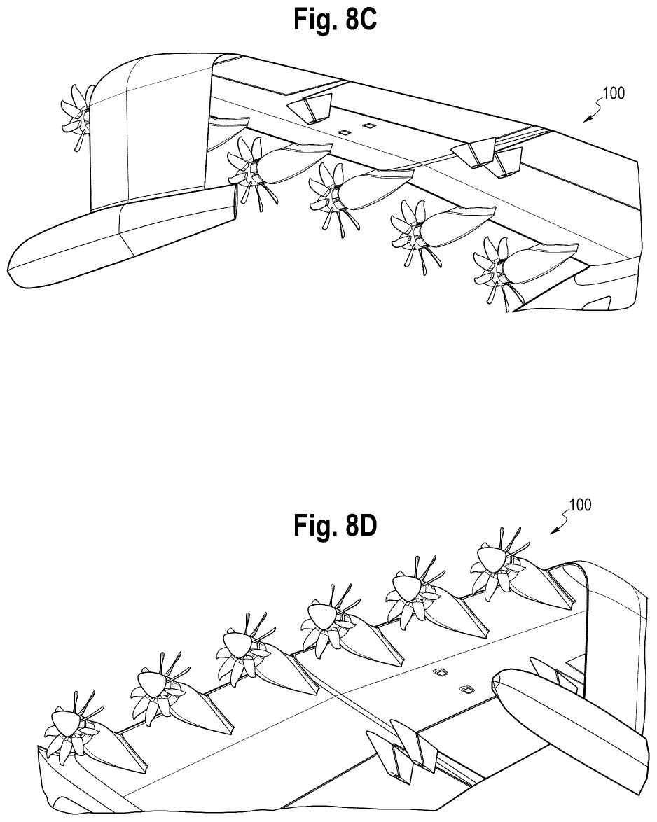

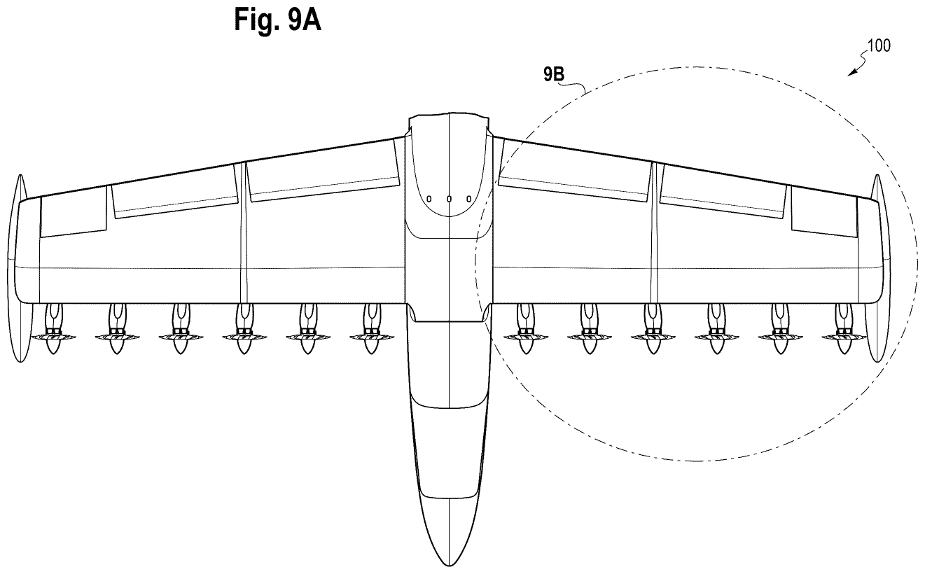

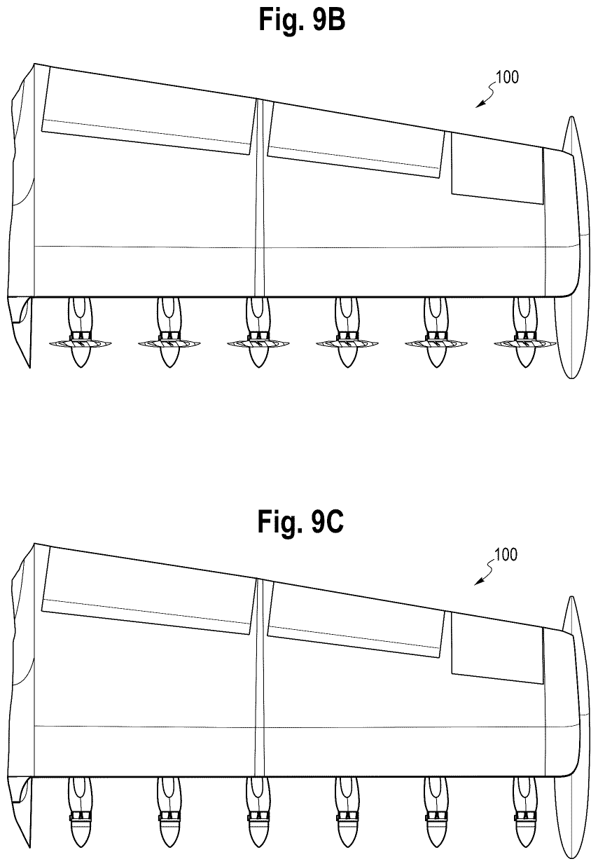

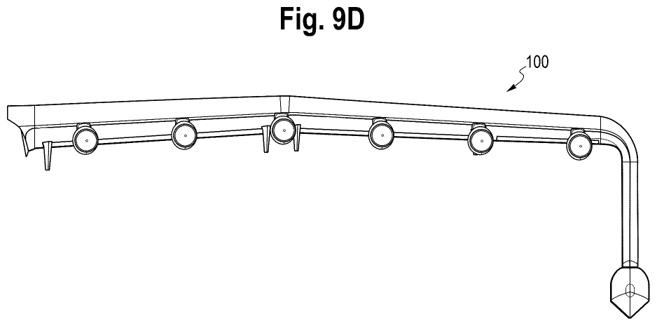

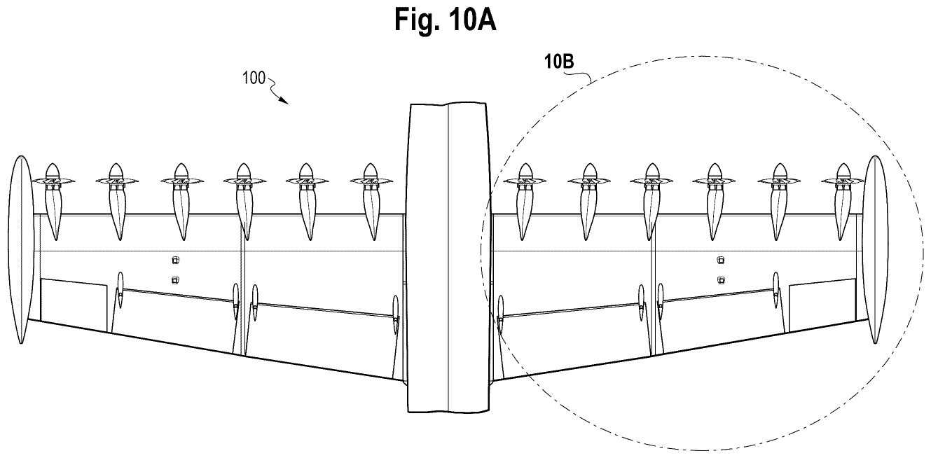

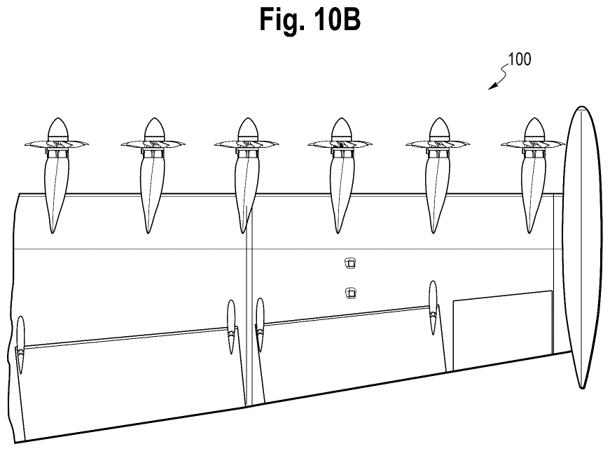

FIGS. 8A-10C are illustrations of various views and modified views of the craft 100, which illustrate the shape and position of the motor pods in this particular example embodiment.

As shown in these drawings and in detail in FIG. 6, the motor pod 600 of this embodiment is canted in that the axis 650 running between a rear point 652 of the motor pod 600 and the center of the motor radius 654 is not co-linear with the axis 660 that is perpendicular to the radius of the motor 630 and the rotation of the propeller 610. As will be discussed in more detail below, the canted design of the motor pod can help address the swirl problem mentioned above, which may be of special concern with blown wing crafts.

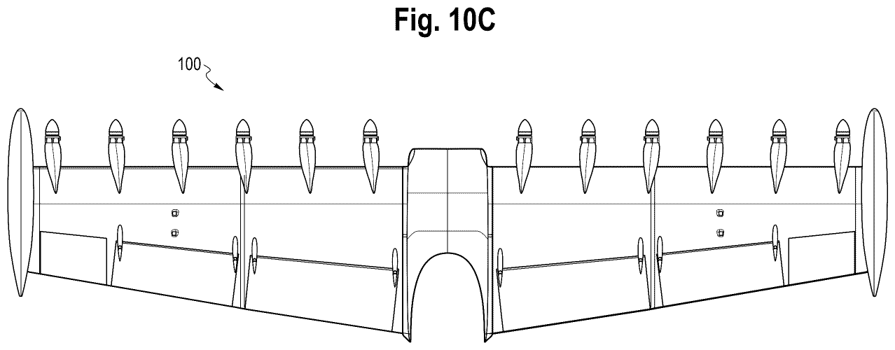

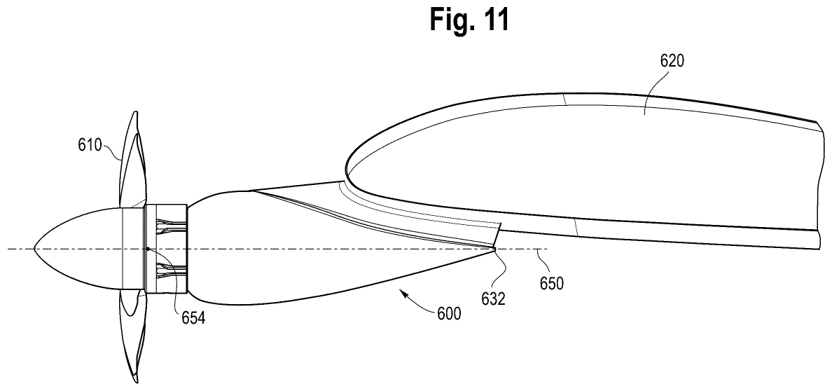

FIG. 11 is a diagram showing another view of the motor pod 600 coupled with the wing 620 of the craft. As shown in FIG. 11, the shape of the motor pod 600 is non-axisymmetric about the axis 650 running from the center of the motor radius 654 to the rear tip 652 of the motor pod 600. Also, the propeller is below the leading edge of the wing.

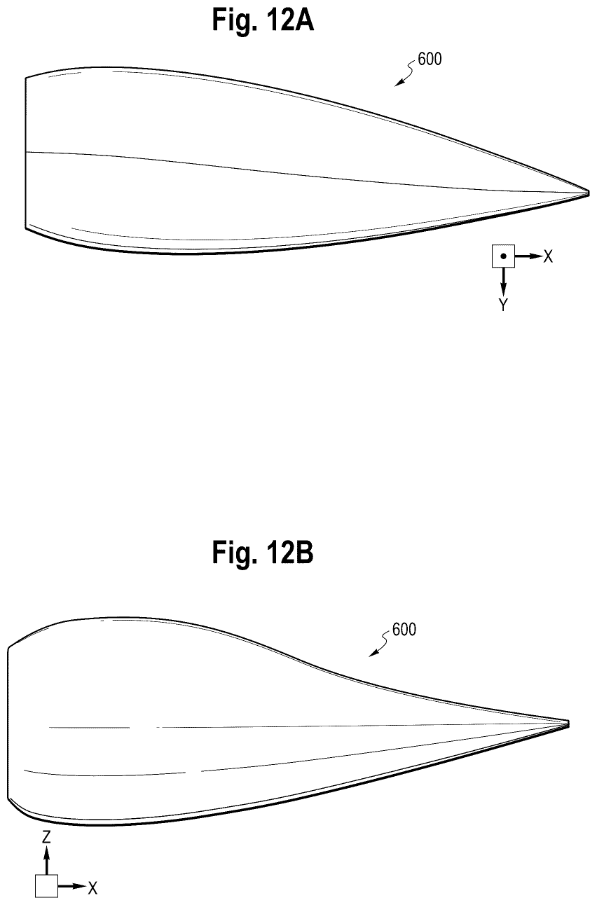

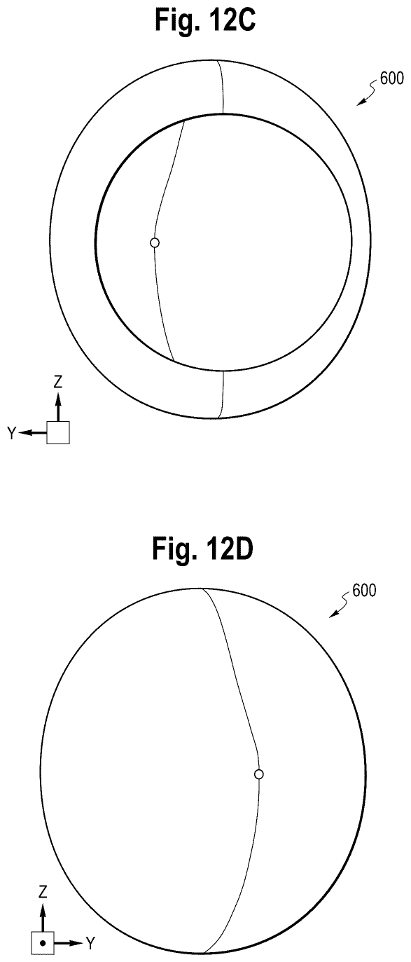

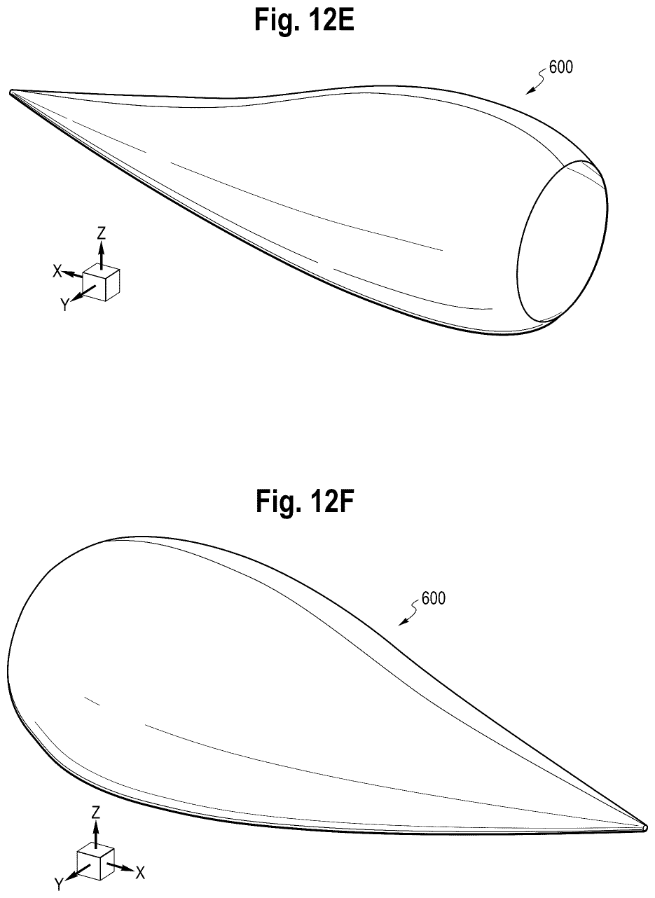

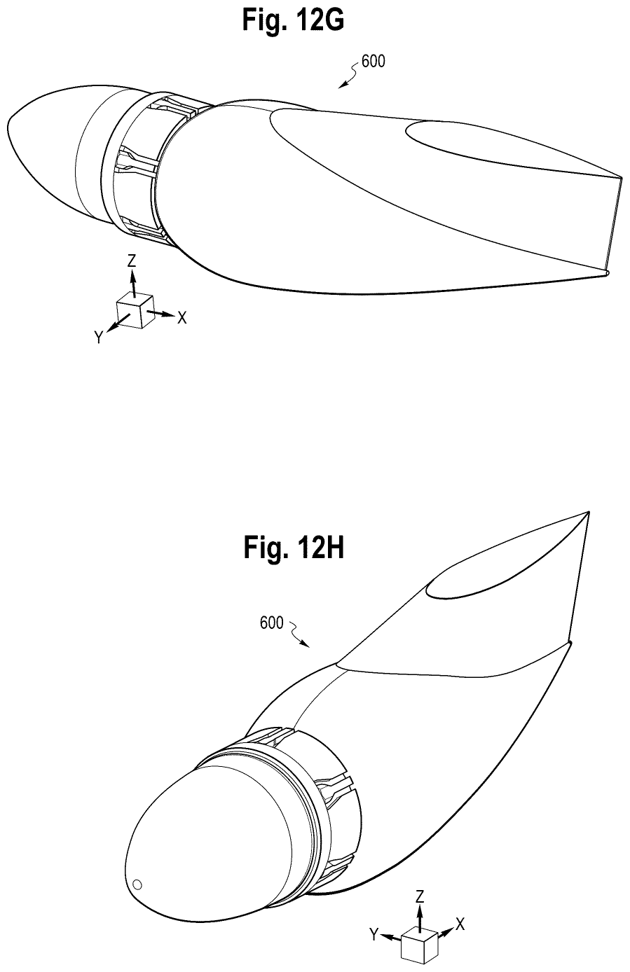

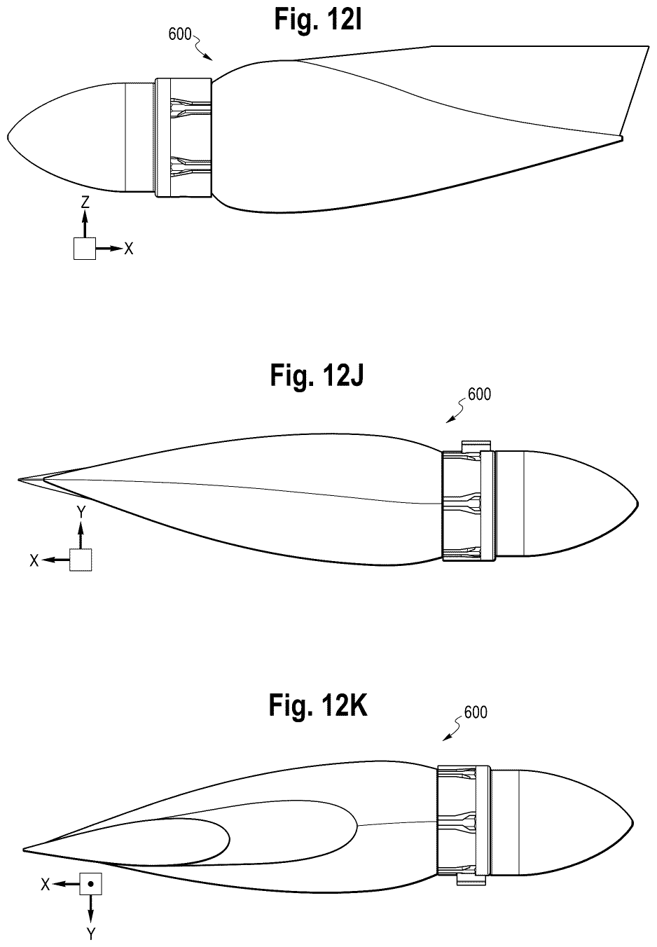

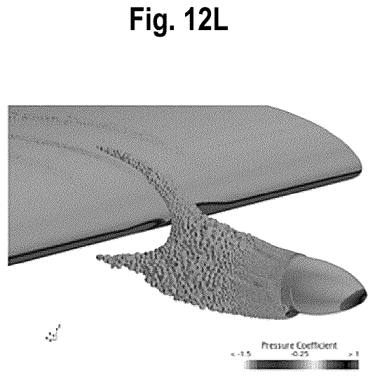

FIGS. 12A-12K are diagrams of various views of the motor pod 600 that further show this asymmetry. (FIGS. 12G and 12H also show a depiction of the motor/propeller element in addition to the motor pod.) It should be understood that other designs can be used. An example of another type of design is shown in FIG. 12L.

The motor pod can be designed in any suitable way. The following paragraphs provide example implementation details. It should be noted that these are merely examples and that other implementations can be used. As such, the details presented herein should not be read into the claims unless expressly recited therein.

The desired and/or optimal motor pod design (cant and bulge) might vary for different stages of flight. However, because the design is static, the design selects so as to attempt to account for all operating states of the craft. Nonetheless, in some approaches, this involves a “focus” on the takeoff domain, where the highest velocity airflow is present.

In one example implementation, the rear tip of motor pod is 80 mm off centerline of the motor axis, and the motor pod is 1130 mm long, which corresponds to an approximately four-degree cant angle of the motor pod. In this example implementation, the motor pod is 50 mm larger than the motor radius on top at maximum thickness, and the motor pod is 42 mm larger than the motor radius on bottom at maximum thickness. Also, the cant is in the same direction as the propeller moves below the wing. So, if the craft has a clockwise propeller rotation as seen from the front and the propeller, when it is underneath the wing, is moving from right to left as seen from the_front, the motor pod would be canted from right to left.

The length can be determined from the flow structures and how quickly the flow can converge back together without separation. This can be a function of motor diameter, velocity, air density, and viscosity. The length is not constrained and is somewhat independent from the angle. The angle is more determined from the swirl of the propeller and its position relative to the wing. Generally, it may be desired for the length to be as short as possible for weight and skin friction reasons.

As noted above, in this example, the cant angle is about four degrees. However, the cant angle can be any suitable angle (e.g., in the range from slightly greater than zero degrees to approximately ten degrees). The chosen angle of cant can depend on several factors. For example, the angle can depend on how far the motor pod is offset from the wing's center (i.e., the vertical distance). It can be anything from zero if the motor is in line with the wing's leading edge, down to quite a significant offset below the wing. This can impact the swirl and resulting undesired pressure differential, thus impacting cant angle. Other factors can include, but are not limited to, propeller direction (clockwise vs counterclockwise), propeller RPM, propeller twist angle, propeller collective angle, propeller airfoil cross-section, propeller size, and freestream velocity (both the design takeoff speed and for maximum lift during takeoff, which would reduce the takeoff speed (e.g., 50 knots with a very high RPM of 3000 RPM), which is particularly helpful for hydrofoil craft and then for the freestream velocity in cruise which would affect the efficiency of the craft and, thus, the range on a given battery capacity.

The motor pod can be constructed from any suitable material. In one example embodiment, the motor pod is a composite material, which may be desired if the chosen shape of the motor pod is difficult or impossible to make using standard “stamped aluminum” manufacturing. In various example implementations, and without limitation, the composite can include carbon, fiberglass, and aramid fibers. Alternatively, the motor pod can be implemented with plastic or stamped metallic parts.

It should be noted that conventional manufacturing techniques are limited and would not make possible doing a canted/organic motor pod. That is, conventional manufacturing techniques would not suggest to one skilled in the art to implement non-axisymmetric/organic motor pods. Also, there are a variety of design/engineering tradeoffs that can be considered, where conventional approaches might be lighter, more structurally efficient, have less manufacturing complexity etc. Accordingly, it is not necessarily evident that it makes sense to use an organic shape made of composites. Instead, composite manufacturing is an enabler of this design, and the particular canted design in this embodiment is enabled by pursuing/using composite manufacturing techniques (whereas conventionally stamped metal approaches would be implemented) such that more complex designs/shapes may be implemented. Conventional straight/narrow components in motor pods are potentially more structurally efficient, lighter, etc., but comes with a penalty in drag compared to the canted design. Through the composites approach, the drag benefits can be achieved while delivering suitable structural integrity. Also, in one embodiment, a computer-rendered example of a relatively-highly-complex shape/surface can theoretically balance/handle airflows well but, in practice, would nonetheless be difficult/impossible to manufacture. Nonetheless, elements of this example might be used to inform a more-practical design (such as attempting to capture important/consequential aspects of the organic shape discussed herein).

Many alternatives can be used with these embodiments. For example, as noted above, the motor pod can take any shape and should not be limited to the shapes discussed above. An example of one alternative shape is shown in FIG. 12L. Again, this is merely an example, and other shapes can be used.

In another alternate embodiment, different motor pod geometries (e.g., angle and shape) are used for the motor pod per the considerations discussed above. For example, the length of the pod can be increased, such as if there is more pressure to recover, perhaps from a larger propeller, a larger pitch, or a higher RPM. If the craft has three propellers instead of six propellers, for instance, but it is desired to have the same total thrust, each motor/propeller can be larger (and possibly with a higher motor RPM), and the cant can be adjusted accordingly. Also, the height/vertical placement of the propeller relative to the wing tip can affect the desired cant because this can impact the relative air flows above/below the wing and, thereby, the pressure differential that it counteracted (a motor pod placed on the top of the wing will sweep/angle a different direction than one on the bottom of the wing).

As another example of an alternate embodiment, various motor pods can be used for each respective motor pod/propeller. For example, different motor pods on the wing(s) can be angled/shaped differently (e.g., if different sized propellers, different RPMs of same propellers, if the height of the motor relative to the wing varies, etc.). Also, a different rotation of propeller direction can mean that the cants go in different directions (e.g., if there are alternative rotating propellers, there can be alternating angles of cant). In one embodiment, the craft comprises a wing with a first and second propeller/motor pod, where the first propeller is one of larger, higher RPM, and/or greater height relative to the wing. As a result, the cant of first propeller is greater than cant of second propeller. In another embodiment, the craft comprises a wing with first and second propellers/motor pods, where the first propeller spins in a first direction (e.g., clockwise) and has a cant in a first direction, and the second propeller spins in a second direction (e.g., counter-clockwise) and has a cant in a second direction, where the first direction is different from the second direction. In yet another embodiment, the craft comprises a first wing with a first propeller that spins in a first direction and has a cant in a first direction and a second wing (e.g., on the other side of the craft) with a second propeller that spins in a second direction and has a cant in a second direction.

As yet another alternative, a motor pod can dynamically change geometries and/or angle. The change can be based on craft operating state. As the propellers spin at lower RPM, there is less swirl (e.g., larger propeller at constant thrust). In such situations. the effect would be less pronounced, and, theoretically, a less-corrective cant would be necessary. The change can also be based on observed pressures. There can be a control theory approach with two sensors on each side and the angle of the motor pod can be tweaked on an ongoing basis to achieve equal pressures on each side.

In other embodiments, the motor pods can be swivel for vertical takeoff and landing. For example, some embodiments may have zero cant for vertical take-off and landing (VTOL) mode and then have an automatic (mechanical or servo/controller) mechanism to restore the optimal cant for forward cruise mode.

Additionally, “flexible surface” technology such as a soft/deformable outer skin utilized for the structure could be utilized with these embodiments in the future. This would involve internal actuation and a different structural design. In such a situation, an internal structure can be used that is responsible for holding/affixing the motor and propeller to the wing, and then the motor pod external structure itself would merely be an outer skin that is deformable (but not structural). This is not an adjustable “control” surface (responsible for maintaining flight); it would be an adjustable “efficiency” surface. Such variable cant can be enabled even with a fixed propeller shaft but with a nacelle made up of movable flaps, such as a directed jet nozzle.

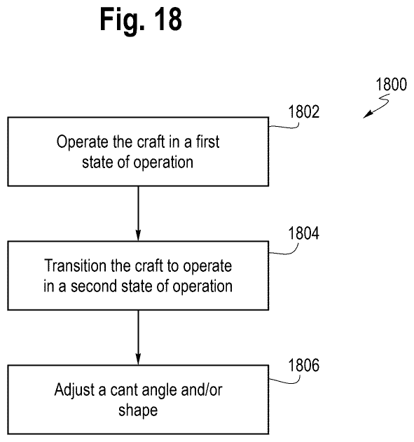

Also, in one embodiment, the craft comprises a control system that can control/change the motor pod cant and/or shape during operation. For example, the craft can comprise at least one processor; a non-transitory computer-readable medium; and program instructions stored on the non-transitory computer-readable medium. As shown in the flow chart 1800 in FIG. 18, when executed by the at least one processor, the program instructions can cause the at least one processor to: dynamically adjust a motor pod characteristic during a mission (any flight plan/trip). More specifically, the program instructions can cause the at least one processor to operate the craft in a first state of operation, wherein a given motor pod has a first cant angle and a first shape (first state of operation could be takeoff) (act 1802), transition the craft to operate in a second state of operation (e.g., after takeoff, transition to cruise mode while in flight) (act 1804), while in second state of operation, adjust at least one of the cant angle to a second cant angle or the shape to s second shape (e.g., cant angle decreases when in cruise, and/or shape becomes relatively more axisymmetric while in cruise) (act 1806). This can include (a) making the change dependent on prop speed, (b) making the change dependent on observed conditions/environment/airflow (such as sensors), etc.

### C. Example Advantages

There are several advantages associated with the example motor pod described above. In general, the design of the motor pod can reduce and/or get rid of air flow “separation” and, as a secondary benefit, equalize air flow pressures. For example, the design of the motor pod of this embodiment can help equalize pressure on the port and starboard sides of the motor pod. It may be desirable in at least some respects for air flow to be equal in all directions at a given streamwise location but, in reality, this may not be able to be achieved due to the influence of the wing on the top side and not the bottom side. So, it may be desired to attempt to equalize pressure at streamwise locations along the motor pod to help ensure there is decreased separation and, that pressure is relatively equalized. There may be trade-offs due to the variety of operating points.

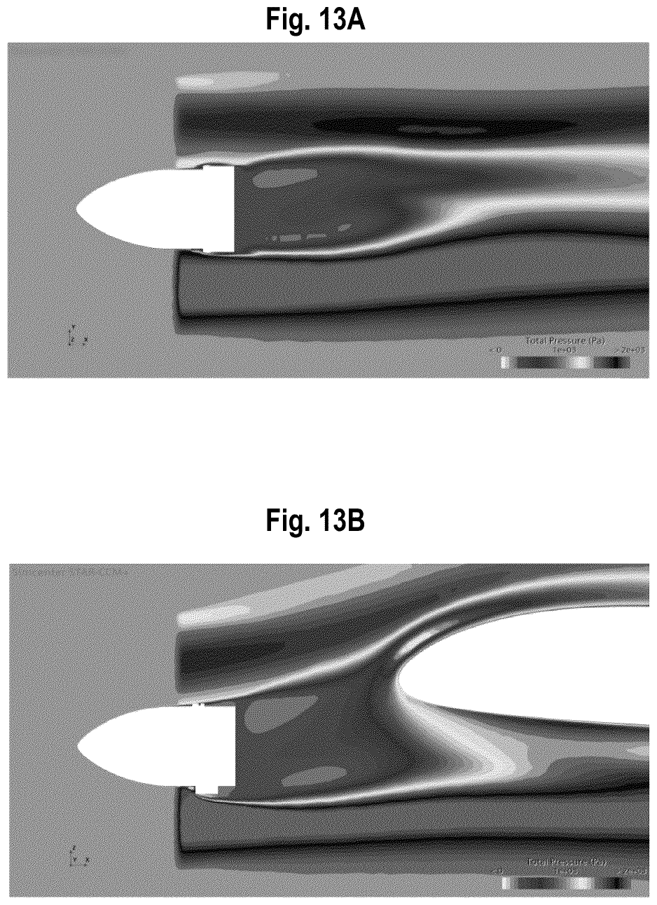

Turning again to the drawings, FIGS. 13A and 13B are top and side views, respectively, that illustrate air flow around a motor pod of an embodiment. These drawings show the loss in total pressure (purple) that the design of the motor pod is trying to address. Orange shows the total pressure, and black shows the increase in total pressure from the velocity jump due to the propeller. FIG. 13B shows that the motor pod design eliminates the purple (low pressure) area and brings the high pressure (black/orange) back to converge on itself. By recapturing the black/orange high pressure with the motor pod, the rear projection of pressure on the back side of the motor goes from low pressure (high drag) to high pressure (low drag). That is, the cant of the motor pod results in the pressure on the left and right sides of the motor_pod being equal, as indicated by the gradient of the colors on the left and right side. So, the geometry (“organic shape”, “tulip shape”) and angle of the motor pod results in the air flow behind the motor being “recaptured” and “rebuilt,” so the pressure is acting equally on the motor pod in all directions, which leads to a reduction in drag.

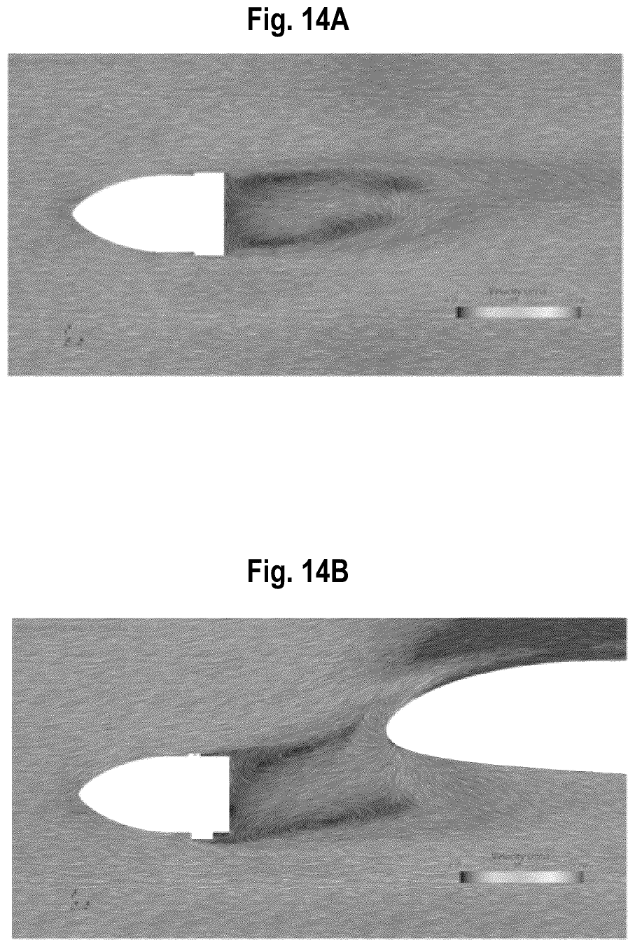

FIGS. 14A and 14B are additional drawings that illustrate the evening-out of the velocity of air flow when the cant is set so that the pressure is equal on both lateral sides (i.e., left and right) of the motor pod. It should be noted that these analyses were considered in multiple relevant operating domains (e.g., take off,_cruise, etc.), and these drawings consider the take-off domain, which may be the most extreme and, in some sense, especially relevant condition). In general, the effects seen at cruise will be the same as those observed_in takeoff, just less pronounced. The design of the motor pod can be based off of observations made in all of the domains.

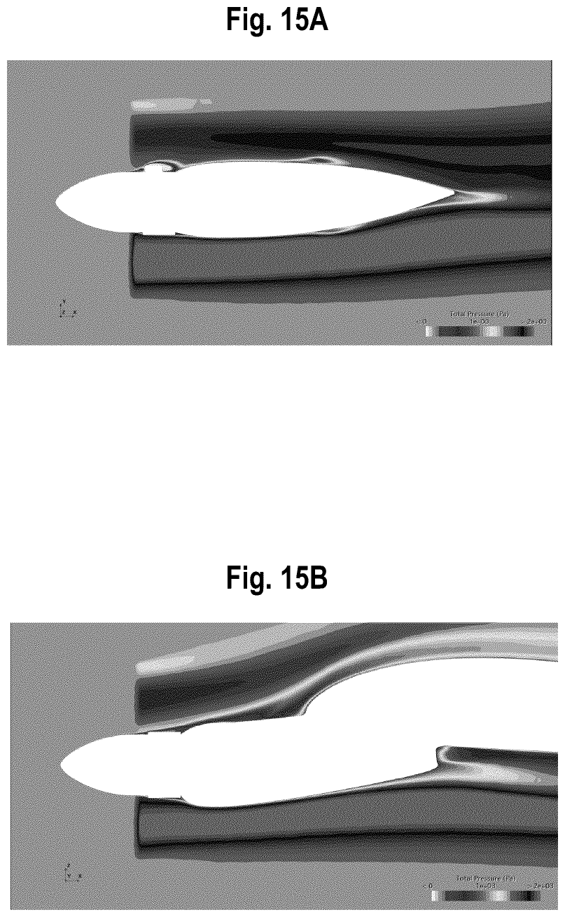

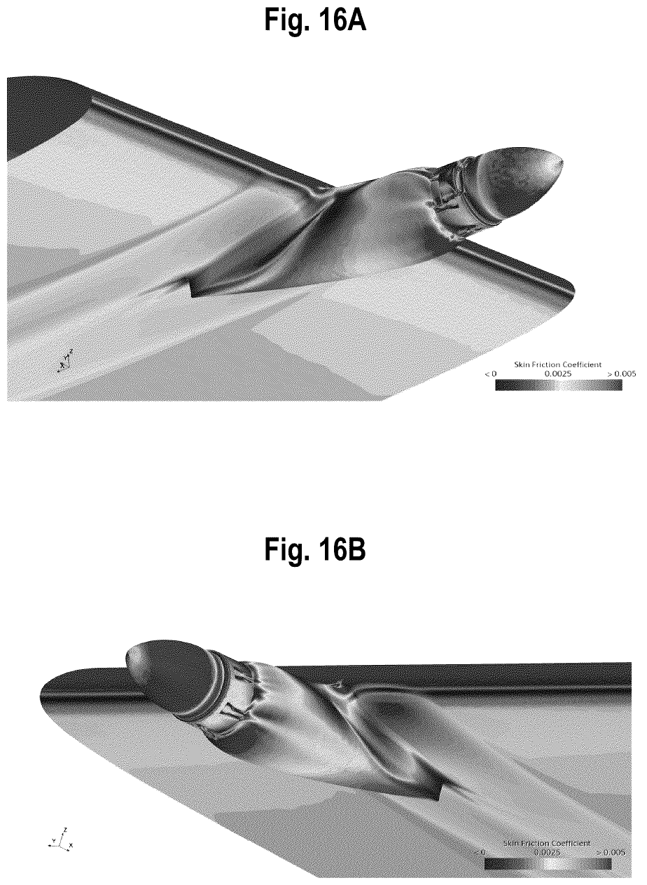

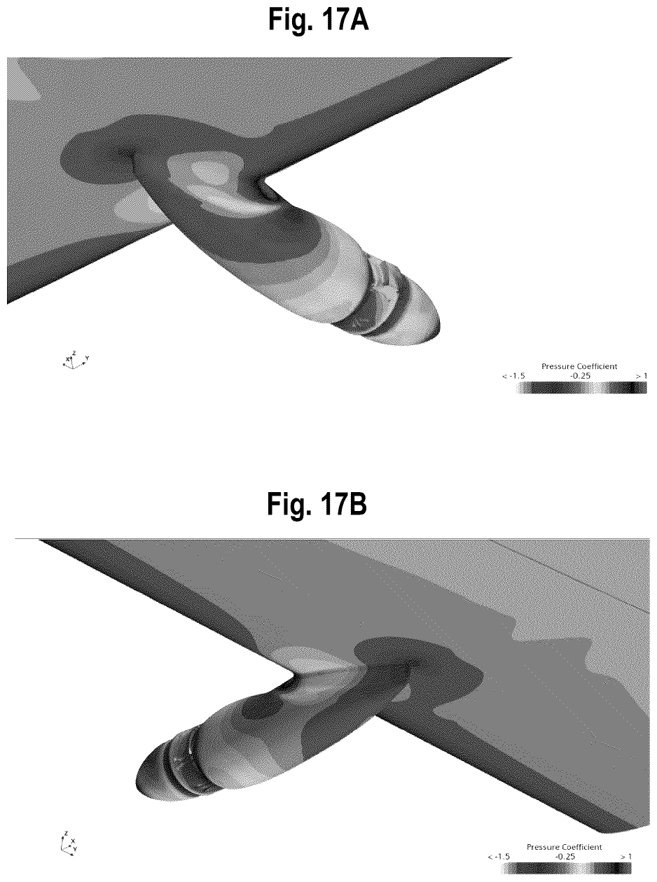

FIGS. 15A, 15B, 16A, and 16B show how pressure is recaptured with the motor pod and illustrates some of the flows from the wing interaction that are challenging to address. FIGS. 17A and 17B show how pressure is recovered by the motor pod and how all the purple low pressure is gone.

In general, it is desirable to attempt to minimize drag, so the lift divided by drag (“L/D”) ratio is increased. These embodiments can reduce drag by reattaching air flow cleanly, which improves/increases pressure under the wing, which generates more lift. The re-attached flow results in clean flow that enables more airflow through slot gaps (formed by flaps when the craft is in takeoff mode), thus adding even more lift. The cleaner the airflow into the flap slots, the more lift the flaps make.

Such an improvement to the L/D ratio increases the efficiency of operation and performance of the craft at all stages of operation, including at takeoff and while flying. In particular, while flying, an improved L/D ratio means that the craft is capable of operating relatively more efficiently while at cruise (normally the longest duration segment of a given trip or mission), a result that is especially impactful for battery-powered craft.

Moreover, regarding the takeoff stage of operation it is of note that the more lift that can be contained at takeoff, the smaller the wing can be. In general, smaller wing design can give rise to a domino effect of benefits including the craft exhibiting more efficiency at cruise. Other such benefits included smaller overall craft size, leading to lower cost or otherwise more efficient manufacturing and assembly.

### IV. Conclusion

Various examples of systems, devices, and/or methods have been described herein. Any embodiment, implementation, and/or feature described herein as being an “example” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein. Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Further, terms such as “A coupled to B” or “A is mechanically coupled to B” do not require members A and B to be directly coupled to one another. It is understood that various intermediate members may be utilized to “couple” members A and B together.

Moreover, terms such as “substantially” or “about” that may be used herein, are meant that the recited characteristic, parameter, or value need not be achieved exactly but that deviations or variations, including, for example, tolerances, measurement error, measurement accuracy limitations and other factors known to skill in the art, may occur in amounts that do not preclude the effect the characteristic was intended to provide.

While the systems and methods of operation have been described with reference to certain examples, it will be understood by those skilled in the art that various changes can be made, and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A craft comprising:
a wing having a leading edge;
a plurality of motor-propeller assemblies distributed along the leading edge of the wing, each motor-propeller assembly comprising:
a propeller positioned forward of the leading edge of the wing;
a motor coupled with the wing and configured to rotate the propeller; and
a motor pod at least partially covering the motor, the motor pod extending rearward from the propeller toward the wing, wherein an axis is defined between a rear end of the motor pod and a center of a radius of the motor, and wherein the axis is non-perpendicular to a rotation of the propeller; and
wherein, for at least one of the plurality of motor-propeller assemblies, a direction of cant of the motor pod is correlated with a direction of rotation of the propeller relative to the wing.

2. The craft of claim 1, wherein the motor pod of at least one of the plurality of motor-propeller assemblies is non-axisymmetric in shape with respect to the axis.

3. The craft of claim 2, wherein the motor pod comprises a tulip shape configured to equalize air pressure on opposite sides of the motor pod.

4. The craft of claim 1, wherein:
the plurality of motor-propeller assemblies comprises at least a first motor-propeller assembly and a second motor-propeller assembly adjacent to the first motor-propeller assembly;
the propeller of the first motor-propeller assembly is configured to rotate in a first rotational direction;
the propeller of the second motor-propeller assembly is configured to rotate in a second rotational direction opposite the first rotational direction; and
the motor pod of the first motor-propeller assembly is canted in a first direction and the motor pod of the second motor-propeller assembly is canted in a second direction different from the first direction.

5. The craft of claim 1, wherein, for at least one of the plurality of motor-propeller assemblies, the motor pod covers a support structure that structurally couples the motor and the wing, and the motor pod is non-structural relative to coupling the motor and the wing.

6. The craft of claim 1, wherein the motor pod of at least one of the plurality of motor-propeller assemblies is made from a composite material.

7. The craft of claim 1, wherein, for at least one of the plurality of motor-propeller assemblies, at least one of power components, communications components, avionics, or control system components is housed within the motor pod.

8. The craft of claim 1, wherein the craft is configured to operate in a ground-effect flight mode in which the wing is within one wingspan of a surface, and the plurality of motor-propeller assemblies are configured to blow air over the wing to generate lift during the ground-effect flight mode.

9. A craft comprising:
a wing;
a propeller;
a motor coupled with the wing and configured to rotate the propeller; and
a motor pod positioned between the propeller and the wing and at least partially covering the motor, wherein an axis is defined between a rear end of the motor pod and a center of a radius of the motor, wherein the axis is non-perpendicular to a rotation of the propeller, wherein the axis is different from a rotational axis of the motor, and wherein the motor pod is non-axisymmetric in shape with respect to the axis.

10. The craft of claim 9, wherein a cross-sectional profile of the motor pod perpendicular to the axis has a greater radial extent on a first side of the axis than on a second side of the axis opposite the first side, and wherein the non-axisymmetric shape is configured to equalize air pressure on a port side and a starboard side of the motor pod.

11. The craft of claim 9, wherein the motor pod is made from a composite material.

12. The craft of claim 9, wherein a direction of cant of the motor pod is correlated with a direction of rotation of the propeller relative to the wing.

13. The craft of claim 9, wherein the motor pod covers a support structure that structurally couples the motor and the wing, and the motor pod is non-structural relative to structurally coupling the motor and the wing.

14. The craft of claim 13, wherein the axis is different from a longitudinal axis of the support structure.

15. The craft of claim 13, wherein at least one of power components, communications components, avionics, or control system components is housed within the motor pod between the support structure and an outer surface of the motor pod.

16. A craft comprising:
a wing;
a propeller;
a motor coupled with the wing and configured to rotate the propeller;
a support structure structurally coupling the motor and the wing; and
a motor pod positioned between the propeller and the wing and at least partially covering the motor and at least partially covering the support structure, wherein the motor pod is non-structural relative to structurally coupling the motor and the wing, wherein an axis of the motor pod is defined between a rear end of the motor pod and a center of a radius of the motor, wherein the axis of the motor pod is non-perpendicular to a rotation of the propeller, and wherein the axis of the motor pod is different from a longitudinal axis of the support structure.

17. The craft of claim 15, wherein the motor pod comprises a first half and a second half, wherein the first half and the second half together cover the support structure.

18. The craft of claim 15, wherein the motor pod is non-axisymmetric in shape with respect to the axis of the motor pod.

19. The craft of claim 15, wherein the axis of the motor pod is different from a rotational axis of the motor.

20. The craft of claim 15, wherein at least one of power components, communications components, avionics, or control system components is housed within the motor pod between the support structure and an outer surface of the motor pod.
